(19) United States
(12) Patent Application Publication
(10) Pub. No.: US 2021/0138446 A1
(43) Pub. Date: May 13, 2021

(54) PARTICULATE COMPOSITIONS HAVING LOW FINES CONTENT

(71) Applicant: ExxonMobil Research and Engineering Company, Annandale, NJ (US)

(72) Inventors: William A. Lamberti, Stewartsville, NJ (US); William C. Horn, Long Valley, NJ (US); Corrine L. Brandl, Beaumont, TX (US); Harry W. Deckman, Clinton, NJ (US)

(21) Appl. No.: 17/061,886

(22) Filed: Oct. 2, 2020

Related U.S. Application Data
(60) Provisional application No. 62/934,073, filed on Nov. 12, 2019.

(51) Int. Cl. B01J 35/00; B01J 35/02; B01J 31/06; B01J 31/14; B01J 37/00

(52) U.S. Cl. CPC B01J 35/0013; B01J 35/026; B01J 35/0006; B01J 37/0072; B01J 31/143; B01J 31/146; B01J 31/06

(57) ABSTRACT

Particulate compositions, especially particulate compositions which are designed to be processed or transferred, are provided. The particulate compositions contain parent particles and composite particles, the composite particles being composed of a binder and fine parent particles. The particulate compositions have a low proportion of free fine parent particles and provide advantages where processing or transferring of the particulate compositions is practiced.

### FIELD

This disclosure relates to particulate compositions, especially particulate compositions designed to be processed or transferred. The particulate compositions contain parent particles and composite particles, the composite particles being composed of fine parent particles and a binder that favors agglomeration with fine particles. As a result, the particulate compositions have a lower proportion of free fine parent particles than would have existed in the absence of binder. This is advantageous where processing or transferring of the particulate compositions is practiced.

### BACKGROUND

Fine particle (commonly referred to as “fines”) reduction and control can present challenges in the handling or use of powdered or granular materials, as well as in process systems where fines are produced due to chemical reaction or due to attrition.

When the powdered or granular materials also possess catalytic properties, overactive catalyst surfaces and catalyst fines can lead to problematic fouling in a range of catalytic processes. The fouling can occur due to entrainment of fine particles overhead into a recycle line, or can occur anywhere in the processing system, such as the reactor vessel, piping, heat exchangers, and so forth.

Commercial practice often overlooks the role of fines in a process or reactor system. Attempts to measure particle size distributions, for example, if performed using sieving methods followed by weighing of each size fraction, will underestimate the population of fines. In these gravimetric methods, the fines are greatly under counted because they often adhere to the larger dry particles, and get counted in with larger particles. Additionally, even properly separated and counted, fines will weigh less than the same number of larger particles due to their inherently lighter weight (which scales as the cube of the particle diameter). Many fouling issues are dependent not on the weight of particles used, but on the number of active particles present in a zone, or on a surface such as at a reactor wall or heat exchanger. Even so, the current state of the art is to reduce fines content through formulation routes such as utilization of carrier materials with a particle size distribution that exhibits fewer fines. This is typically an expensive and irreproducible route. Other methods to reduce fines typically involve time and energy intensive steps such as sieving or some other means of separation prior to use of the powder in the process unit. In situ methods of fines reduction typically involve process hardware such as filters, cyclones or electrostatic precipitators, which themselves are prone to fouling and increase the maintenance and cost of the overall process system.

Many process units exhibit operational difficulty due to the presence of excessive fines within the process unit or reactor system. Fluidized beds provide a good example. For example, in a gas phase fluidized bed reactor with active olefin polymerization catalysts, the fine particles are preferentially entrained and carried overhead into a recycle gas line where fouling of the recycle system or distributor plate can then occur. The reactor hardware is designed to minimize this effect through the inclusion of a disengagement zone, or expanded section and dome, based upon a presumed particle size and density at a given fluidization condition. Some practitioners also utilize a cyclone separator in the dome, which can also experience fouling. If the particle size range shifts to finer particles, or if the fluidization conditions are even momentarily more energetic, then increased particle carryover can result.

Processes which make use of powdered or granular materials include, but are not limited to, gas phase polymerization of olefins, phthalic and maleic anhydride synthesis, fluidized catalytic cracking, Fischer Tropsch synthesis of hydrocarbons and acrylonitrile synthesis.

United States Patent Application Publication No. US2002/0000488 discloses compositions comprising carboxylate metal salts in combination with an olefin polymerization catalyst. The disclosed compositions resulted in less reactor fouling in slurry and gas phase polymerization processes.

It spite of the numerous methods available to address the challenges fine particles present, a need exists to identify further improvements. The present disclosure addresses this need.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY

The present disclosure is directed to new particulate compositions and to processes for their preparation and use. The compositions comprise mixtures of parent particles and composite particles so designed to minimize the amount of undesirable fine parent particles in the compositions, that is parent particles having a maximum particle size below a particular limit.

The particulate compositions may be produced by treating parent particles with binders which promote agglomeration of fine parent particles into composite particles of a larger, desired size range for the process at hand, such as, for example, a process utilizing a fluidized bed. The binder assists in promoting agglomeration of only the smallest parent particles, thus improving physical properties of the particulate composition, which tune or control carryover or entrainment. In some embodiments the binders may be used either before the parent particles are added to a process unit, or while the process unit is operational. In some embodiments the binders may also impart additional chemical or catalyst activity control, poison control, activity improvement or desired physical properties such as increased density, surface or bulk conductivity, for example.

In one aspect the present disclosure provides a particulate composition comprising:

a) a first fraction of parent particles; and

b) composite particles, said composite particles comprising a binder and a second fraction of parent particles,

wherein the second fraction of parent particles has a maximum particle size which is less than the volume average particle size of the first fraction of parent particles; and wherein the first and second fractions of parent particles comprise the same material.

In some embodiments the second fraction of parent particles has a maximum particle size which is less than 50% of the volume average particle size of the first fraction of parent particles.

Preferably the second fraction of parent particles has a maximum particle size which is less than 40% of the volume average particle size of the first fraction of parent particles, or less than 30%, or less than 20%, or less than 10%, or less than 5%, or less than 2%, or less than 1%.

In some embodiments the maximum particle size of the second fraction of parent particles is less than about 5 micron, or less than about 3 micron, or less than about 2 micron, or less than about 1 micron.

In some embodiments the volume average particle size of the first fraction of parent particles is about 5 micron or greater, or about 10 micron or greater, or about 20 micron or greater.

In some embodiments the volume average particle size of the first fraction of parent particles is between about 5 micron and about 500 micron, or between about 5 micron and about 200 micron, or between about 5 micron and about 100 micron, or between about 5 micron and about 50 micron.

In some embodiments the volume average particle size of the composite particles is between about 5 micron and about 500 micron, or between about 5 micron and about 200 micron, or between about 5 micron and about 100 micron or between 5 micron and about 50 micron.

In some embodiments the particulate composition comprises less than about 5% by weight of free parent particles having a volume average particle size of less than 5 micron based on the total weight of the parent particles.

Preferably, the particulate composition comprises less than about 4%, or less than about 3%, or less than about 2%, or less than about 1%, or less than about 0.5%, or less than about 0.1% of free parent particles having a volume average particle size of less than 5 micron.

The composite particles may comprise at least a portion of the second fraction of parent particles associated with an external surface of binder particles.

In some embodiments the parent particles are selected from the group consisting of inorganic oxides, including metal and non-metal oxides, metals, metal halides, carbon, and polymers.

Suitable inorganic oxide parent particles include Groups 2, 4, 13, and 14 metal oxides, such as silica, alumina, magnesia, titania, zirconia, and the like, and mixtures thereof. Suitable polymeric parent particles include finely divided polyolefins, such as finely divided polyethylene or polypropylene.

Particularly useful parent particles include silica, magnesia, titania, zirconia, montmorillonite, phyllosilicate, zeolites, talc, clays, and the like. Also, combinations of these parent particles may be used, for example, silica-chromium, silica-alumina, silica-titania, and the like.

In some preferred embodiments, the parent particles comprise silica, for example, amorphous silica, which may include a hydrated surface including hydroxyl or other groups which can react with other materials to functionalize the surface. Other parent particles may optionally be present with the preferred silica as a co-parent, for example, talc, other inorganic oxides, zeolites, clays, organoclays, or any other organic or inorganic parent particles and the like, or mixtures thereof.

Suitable metal halides include, for example, magnesium chloride.

The parent particles may further comprise one or more metal compounds. In some embodiments the metal compounds perform a catalytic function.

The parent particles may further comprise one or more transition metal compounds.

The transition metal compound may be a bulky ligand transition metal compound, particularly a bulky ligand transition metal compound, which, when suitably activated, is capable of polymerizing olefins.

The parent particles may further comprise one or more metal alkyl moieties, such as, for example, aluminum alkyls or alumoxanes.

The parent particles may further comprise one or more boron containing olefin polymerization catalyst activators.

The binder is a chemical species or material that promotes the agglomeration of fine parent particles to produce composite particles comprising binder and fine parent particles.

Preferred binders are those chemical species or material which produce composite particles having a volume average particle size which is within about 50% of the volume average particle size of the parent particles, or within about 40%, or within about 30%, or within about 20%.

The binder may be selected from the group consisting of metal carboxylates, waxes, low molecular weight polymers, cross-linkable compounds, epoxies, metal hydroxide gels, and other materials that promote adhesion and agglomeration between smaller particles.

The metal carboxylate may comprise one or more aluminum carboxylates, such as aluminum stearate or aluminum di-stearate. In some embodiments aluminum stearate and aluminum di-stearate are equivalent in respect of binder efficacy.

In some embodiments the binder is present in an amount of up to about 25% by weight based on the total weight of particulate composition, or between about 0.1% and about 25%, or between about 0.1% and about 15%, or between 0.1% and about 10%, or between about 0.1% and about 5%, or between about 0.5% and about 5%.

In some embodiments the particulate composition possesses catalytic activity.

In some embodiments the parent particles possess catalytic activity.

In some embodiments the composite particles possess catalytic activity.

In some preferred embodiments the catalytic activity is moderated by the binder.

In one embodiment the catalytic activity of fine parent particles is moderated or substantially eliminated. In another embodiment the catalytic activity of parent particles having poor active site distribution is controlled or moderated.

The particulate compositions of the present disclosure may comprise one or more of increased density, increased surface conductivity or increased bulk conductivity, relative to a particulate composition absent binder.

In some embodiments the binder controls the physical and/or chemical properties of the composite particles. The physical and/or chemical properties may include one or more of catalytic activity, particle density, particle magnetic properties and particle electric properties.

In some embodiments the control of properties improves one or more aspects of process performance when the particulate composition is used therein.

Examples of aspects of process performance may include particle fluidization, particle segregation within a bed or system, tailored catalytic activity and catalytic selectivity.

In another aspect of the present disclosure there is provided a process for preparing a particulate composition comprising the step of contacting at least one binder with parent particles under conditions effective to produce

a) a first fraction of parent particles; and

b) composite particles, said composite particles comprising the binder and a second fraction of parent particles,

wherein the second fraction of parent particles has a maximum particle size which is less than the volume average particle size of the first fraction of parent particles; and wherein the first and second fractions of parent particles comprise the same material.

In some embodiments the binder may be contacted with the parent particles prior to the parent particles being subjected to processing. Such processing may be chemical or physical processing and combinations thereof.

In other embodiments the binder may be added to the parent particles during processing operations, for example the binder may be added to a reactor, to a transfer system or to a storage vessel.

In another aspect of the present disclosure there is provided a process, said process comprising the step of conveying a particulate composition according to any one or more of the herein disclosed embodiments.

In some embodiments the conveying occurs in a pipe, a vessel, a mixer, a transfer line, a reactor and the like.

In some embodiments the conveying occurs in a fluidized bed reactor.

In another aspect of the present disclosure there is provided a use of a particulate composition according to any one or more of the herein disclosed embodiments in a particle conveying process.

Processes in which the particulate compositions of the present disclosure may be well suited include, but are not limited to, gas phase polymerization of olefins, phthalic and maleic anhydride synthesis, fluidized catalytic cracking, Fischer Tropsch synthesis of hydrocarbons and acrylonitrile synthesis.

In another aspect there is provided a process for polymerizing olefins comprising contacting olefins with one or more particulate compositions, said particulate compositions comprising:

a) a first fraction of parent particles; and

b) composite particles, said composite particles comprising a binder and a second fraction of parent particles,

wherein the second fraction of parent particles has an maximum particle size which is less than the volume average particle size of the first fraction of parent particles;
wherein the first and second fractions of parent particles comprise the same material; and
wherein the parent particles further comprise an activator, and one or more catalyst compounds comprising a titanium, a zirconium, a chromium or a hafnium atom.

Further features and advantages of the present disclosure will be understood by reference to the following drawings and detailed description.

### BRIEF DESCRIPTION OF THE DRAWINGS

FIG. 1 is a backscattered electron micrograph of a particulate composition according to one embodiment of the present disclosure.

FIG. 2 is an induced X-ray aluminum compositional map of an epoxy embedded cross section of a particulate composition according to one embodiment of the present disclosure.

FIG. 3 is an induced X-ray silicon compositional map of an epoxy embedded cross section of a particulate composition according to one embodiment of the present disclosure.

FIG. 4 is an induced X-ray carbon compositional map of an epoxy embedded cross section of a particulate composition according to one embodiment of the present disclosure.

FIG. 5 is an FTIR spectrum of a particulate composition according to one embodiment of the present disclosure.

FIG. 6 is a backscattered electron micrograph of a particulate composition according to another embodiment of the present disclosure.

FIG. 7 is an induced X-ray aluminum compositional map of an epoxy embedded cross section of a particulate composition according to another embodiment of the present disclosure.

FIG. 8 is an induced X-ray silicon compositional map of an epoxy embedded cross section of a particulate composition according to another embodiment of the present disclosure.

FIG. 9 is an induced X-ray carbon compositional map of an epoxy embedded cross section of a particulate composition according to another embodiment of the present disclosure.

### DETAILED DESCRIPTION OF THE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any processes and materials similar or equivalent to those described herein can also be used in the practice or testing of the present disclosure, the preferred processes and materials are now described.

It must also be noted that, as used in the specification and the appended claims, the singular forms ‘a’, ‘an’ and ‘the’ include plural referents unless otherwise specified. Thus, for example, reference to ‘binder’ may include more than one binder, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

Unless specifically stated or obvious from context, as used herein, the term “about” is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any processes provided herein can be combined with one or more of any of the other processes provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

As used herein, the term “catalytic activity”, where appropriate, is meant to include all useful catalytic performance metrics for a catalyst such as selectivity, poison resistance, lifetime, and so forth.

As used herein, particle size (PS) or diameter, and distributions thereof, are determined by laser diffraction, with appropriate particle dispersion techniques and by reference to appropriate standards, using, for example, a MASTERSIZER 3000 (range of 0.01 to 3500 μm) available from Malvern Instruments, Ltd., Worcestershire, England. Other suitable instruments include, for example, Horiba LA-950A2 or LA-960 available from Horiba Instruments Inc. Average particle size refers to the distribution of particle volume with respect to particle size, unless stated otherwise. Unless otherwise indicated expressly or by context, “particle” refers to the overall particle body rather than subunits or parts of the body such as the “primary particles” in agglomerates.

The size of a fine parent particle may be determined by the actual process conditions which result in preferred entrainment or segregation of the particles based upon their smaller average size, density and aero/hydrodynamic drag, which together translate into an effective entrainment or buoyancy in the process at hand. Herein, the descriptor particle size is utilized, however it will be apparent that entrainment effects are dependent upon these combined factors. Additionally, it will be recognized that effective particle diameter is dependent upon the actual three-dimensional shape of the particles, and particle size is used herein as a descriptor of whatever geometric measure is appropriate for the process and particulate system at hand. In some embodiments “equivalent spherical diameter” may be an appropriate descriptor.

The particulate compositions of the present disclosure allow parent particles containing an undesired level of fine parent particles to be used in a process unit that would otherwise experience sub-optimal performance due to the presence of these fines. For example, in a gas phase fluidized bed reactor wherein the parent particles comprise an active olefin polymerization catalyst, the fine parent particles are preferentially entrained and carried overhead into a recycle gas line where fouling of the recycle system or distributor plate can then occur. Reduction of the quantity of fine parent particles can lead to fouling reduction and improved operational performance Additionally, if the binder also acts as a poison for the catalyst system at hand, and exhibits low volatility and/or solubility, it can preferentially deactivate any fine parent particles, which further reduces fouling tendency in the process unit or reactor system. In the case where larger particles have overactive surface sites due to suboptimal active site distributions throughout a supported catalyst particle, the binder can also act as a moderator of overactive large catalyst particles, again helping to reduce fouling tendencies in a given system.

The present disclosure envisages the use of binders to reduce the fines population at any stage of the production or use of a particulate parent. Other methods to reduce fines typically involve time and energy intensive steps such as sieving or some other means of separation prior to use of the particulate parent in a process unit.

In situ methods of fines reduction typically involve process hardware such as filters, cyclones or electrostatic precipitators, which themselves are prone to fouling and increased maintenance and cost of the overall process system. Binders can be used prior to particles being introduced into the process unit, and physically mixed, sprayed, or stirred ahead of time to promote fines agglomeration.

Binders can also be added while the process unit is operational, to help reduce fines content and moderate over-active parent particles, such as catalysts. The binders can be introduced as part of normal operation, or as a response to a process indicator or alarm that indicates fines reduction or catalyst moderation would be beneficial.

In certain embodiments the compositions and/or processes of the present disclosure may possess one or more of the following advantages:
The use of binders is inherently of much lower energy use than that of other particle separation processes. Any mixing step required can be achieved as part of an already existing step in the production of the particulate composition, including catalytically active particulate compositions, with no or minimal added energy input into the process.
The use of binders can be employed at any stage of the particulate composition production or use process, whichever is most beneficial for the circumstance at hand. For example, binders can be added after a particulate composition is prepared, but prior to use in a process unit. Alternatively, binders can be added while an operating process unit is running, to help alleviate process instabilities, minimize carryover, or reduce fouling events.
The binders can be used to moderate the activity of an over active catalytic particulate composition either as part of the catalyst preparation step, or added while a process unit is running if indications such as catalyst productivity or reactor temperature warrant such a step.
The binders can be used to alter other properties of the composite particles, such as catalytic or chemical activity, particle density, particle magnetic or electrical properties, for example. This change in physical or chemical property can be tailored and used to enhance performance in a variety of process aspects such as fluidization, segregation within a bed or system, tailored catalytic activity or selectivity, and so on forth.

The particulate compositions of the present disclosure may possess catalytic activity. In one form, the particulate compositions are catalysts for olefin polymerization.

A particulate composition for olefin polymerization includes one or more catalyst components utilized to polymerize olefins, at least one particulate support and may also include at least one activator or alternatively or additionally, at least one cocatalyst.

As used herein, a “catalyst compound” may include any compound that, when activated, is capable of catalyzing the polymerization or oligomerization of olefins, wherein the catalyst compound comprises at least one Group 3 to 12 atom, and optionally at least one leaving group bound thereto.

Catalyst compounds may be conventional Ziegler-Natta catalysts and Phillips-type chromium catalysts well known in the art. Alternatively, the catalyst compounds may be metallocene or other single-site catalysts.

Suitable co-catalysts include co-catalysts well known in the art of olefin polymerization, for example tri-n-butylaluminum, di-isobutyl ethylboron, di-n-butylzinc and tri-n-amylboron, and, in particular, aluminum alkyls, such as tri-hexyl-aluminum, triethylaluminum, trimethylaluminum, and tri-isobutylaluminum. Other examples include di-isobutylaluminum bromide, isobutylboron dichloride, methyl magnesium chloride, di-isobutylaluminum hydride, diethylboron hydride, dipropylboron hydride, butylzinc hydride, dichloroboron hydride, and di-bromo-aluminum hydride.

An activator is defined in a broad sense as any combination of reagents that increases the rate at which a transition metal compound oligomerizes or polymerizes unsaturated monomers, such as olefins.

In some embodiments, alumoxanes may be utilized as activators. Alumoxanes are generally oligomeric compounds containing —Al(R)—O— subunits, where R is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators.

In some embodiments, an ionizing or stoichiometric activator, neutral or ionic, such as tri (n-butyl) ammonium tetrakis (pentafluorophenyl) boron, trisperfluorophenyl boron, trisperfluoronapthyl boron, polyhalogenated heteroborane anions, boric acid or combinations thereof, may be used. The neutral or ionic activators may be used alone or in combination with alumoxane or modified alumoxane activators.

The above described catalyst compounds, co-catalysts and activators are combined with one or more particulate supports so as to provide the parent particles as disclosed herein,

As used herein, the term “support” refers to compounds comprising Group 2, 3, 4, 5, 13 and 14 oxides and chlorides. Suitable supports include, for example, silica, magnesia, titania, zirconia, montmorillonite, phyllosilicate, alumina, silica-alumina, silica-chromium, silica-titania, magnesium chloride, graphite, and the like.

The support may possess a volume average particle size in the range of from about 0.1 to about 500 micron, or from about 1 to about 200 micron, or from about 1 to about 50 micron, or from about 5 to about 50 micron.

The support may have an average pore size in the range of from about 10 to about 1000 \acute{Å}, or about 50 to about 500 \acute{Å}, or 75 to about 350 \acute{Å}.

The support may have a surface area in the range of from about 10 to about 700 m²/g, or from about 50 to about 500 m²/g, or from about 100 to about 400 m²/g.

The support may have a pore volume in the range of from about 0.1 to about 4.0 cc/g, or from about 0.5 to about 3.5 cc/g, or from about 0.8 to about 3.0 cc/g.

In one embodiment, a binder as hereinbefore described is introduced directly into the polymerization reactor independently of the parent particles. In an embodiment, the binder is in the form of a slurry in a suitable liquid vehicle.

Polymerization processes may include gas phase processes. In illustrative embodiments, a gas phase polymerization of one or more olefins at least one of which is ethylene or propylene is provided.

The particulate compositions as hereinbefore described are suitable for use in any gas phase pre-polymerization and/or polymerization process over a wide range of temperatures and pressures. The temperatures may be in the range of from −60° C. to about 280° C., preferably from 50° C. to about 200° C.; and from 60° C. to 120° C. in yet a more particular embodiment, and from 70° C. to 100° C. in yet another embodiment, and from 80° C. to 95° C. in yet another embodiment.

In one embodiment, the present process is a gas phase polymerization process of one or more olefin monomers having from 2 to 30 carbon atoms, preferably 2 to 12 carbon atoms, and more preferably 2 to 8 carbon atoms. The process is particularly well suited to the polymerization of two or more olefins or co-monomers such as ethylene, propylene, 1-butene, 1-pentene, 4-methyl-1-pentene, 1-hexene, 1-octene, 1-decene or the like.

Preferred binders include metal carboxylate salts such as any mono- or di- or tri-carboxylic acid salts containing a metal from the Periodic Table of Elements. Examples include, but are not limited to saturated, unsaturated, aliphatic, aromatic or alicyclic carboxylic acid salts where the carboxylate ligand has preferably from 2 to 24 carbon atoms, such as acetate, propionate, butyrate, valerate, pivalate, caproate, isobuytlacetate, t-butyl-acetate, caprylate, heptanate, pelargonate, undecanoate, oleate, octoate, palmitate, myristate, margarate, stearate, arachate and tercosanoate.

### Examples

Parent particles according to the present disclosure were prepared by treating a particulate amorphous silica with methylalumoxane and a bulky ligand zirconium compound to yield parent particles having a volume average particle size of about 50 micron. The parent particles were treated with aluminum di-stearate binder to yield a particulate composition. The composition contained 3% by weight aluminum di-stearate based on the total weight of the particulate composition. The particulate composition was analyzed by electron microscopy and infra-red spectroscopy.

FIG. 1 is a backscattered electron micrograph of the particulate composition. The darker particle in the center of the micrograph is a composite particle which comprises a binder particle and fine silicon containing parent particles. The fine particles are lighter in color. The other particles in the micrograph of lighter color are mainly parent particles of larger size. It can be seen that the binder particle in the center of the photograph has bound many of the fine parent particles. The contrast in this image is largely atomic number based, which accounts for the darker grey of the composite particle compared to the silica for other particles. This composite particle then conveys or fluidizes and entrains more like a larger silica particle. The activity of the fines is moderated in this case, since stearate is a known poison for this type of catalyst.

FIG. 2 is an electron induced x-ray compositional map of an epoxy embedded cross section of the particulate composition. The micrograph is an aluminum compositional map which highlights particles containing aluminum. The particle within the oval is a composite particle. As the particulate composition contains methylalumoxane it would be expected that all particles contain aluminum.

FIG. 3 is another induced x-ray compositional map of an epoxy embedded cross section of the particulate composition. The micrograph is a silicon compositional map which highlights particles containing silicon. It is evident that the particle enclosed in the oval is lean in silicon, whereas the remaining particles are rich in silicon. The particle highlighted by the oval also shows fine silicon containing particles coating the aluminum di-stearate binder.

FIG. 4 is another electron induced x-ray compositional map of an epoxy embedded cross section of the particulate composition. The micrograph is a carbon compositional map which highlights particles containing carbon. It is evident that the particle enclosed in the oval is carbon based, whereas the remaining particles are lean in carbon.

FIG. 5 is an FTIR spectrum of the particulate composition. The upper spectrum is that of composite particles indicating enhanced level of aluminum di-stearate. Approximate locations of aluminum di-stearate peaks are at 3697 cm⁻¹, 2850 cm⁻¹, 1586 cm⁻¹, and 980 cm⁻¹. The lower spectrum is that of parent particles indicating enhanced levels of silicate. Approximate location of silicate bands from the silica-based particles are at 1068 cm⁻¹ and 789 cm⁻¹.

In another example, a particulate composition according to the present disclosure was prepared by treating a particulate amorphous silica with aluminum di-stearate binder (absent methylalumoxane or zirconium compound). The particulate composition was analyzed by electron microscopy.

FIG. 6 is a backscattered electron micrograph of the particulate composition. The darker particle in the center of the micrograph is a composite particle which comprises a binder particle and fine silicon containing parent particles. The fine particles are lighter in color. The other particles in the micrograph of lighter color are mainly parent silica particles of larger size. It can be seen that the binder particle has bound many of the fine parent particles. The contrast in this image is largely atomic number based, which accounts for the darker grey of the composite particle compared to the silica for other particles. When fluidized or conveyed this composite particle behaves more like a larger parent particle.

FIG. 7 is an electron induced x-ray compositional map of an epoxy embedded cross section of the particulate composition. The micrograph is an aluminum compositional map which highlights particles containing aluminum. Only the central composite particle, highlighted by the oval, and which contains aluminum di-stearate, is visible.

FIG. 8 is another induced x-ray compositional map of an epoxy embedded cross section of the particulate composition. The micrograph is a silicon compositional map which highlights particles containing silicon. It is evident that the particle enclosed in the oval is lean in silicon, whereas the remaining particles are rich in silicon. The particle highlighted by the oval also shows fine silicon containing particles coating the aluminum di-stearate binder.

FIG. 9 is another electron induced x-ray compositional map of an epoxy embedded cross section of the particulate composition. The micrograph is a carbon compositional map which highlights particles containing carbon. It is evident that the particle enclosed in the oval is carbon based. The photograph has been cropped to avoid scattered signal from the substrate.

The results indicate that two quite different parent particle systems, silica and methylalumoxane treated silica, may be effectively modified through the use of an aluminum di-stearate binder. This is unexpected as stearates are typically used to prevent agglomeration in particle systems (see AAPS PharmSciTech, Vol. 14, No. 3, September 2013 (#2013) DOI: 10.1208/s12249-013-0007-5. The Effect of Lubricants on Powder Flowability for Pharmaceutical Application, by Morin and Briens).

### Certain Embodiments

Certain embodiments of compositions and processes according to the present disclosure are presented in the following paragraphs.

Embodiment 1 provides a particulate composition comprising:

a) a first fraction of parent particles; and

b) composite particles, said composite particles comprising a binder and a second fraction of parent particles,

wherein the second fraction of parent particles has a maximum particle size which is less than the volume average particle size of the first fraction of parent particles; and
wherein the first and second fractions of parent particles comprise the same material.

Embodiment 2 provides a particulate composition according to embodiment 1, wherein the second fraction of parent particles has a maximum particle size which is less than 50% of the volume average particle size of the first fraction of parent particles.

Embodiment 3 provides a particulate composition according to embodiment 2, wherein the second fraction of parent particles has a maximum particle size which is less than 40% of the volume average particle size of the first fraction of parent particles, or less than 30%, or less than 20%, or less than 10%, or less than 5%, or less than 2%, or less than 1%.

Embodiment 4 provides a particulate composition according to any one of embodiments 1 to 3, wherein the maximum particle size of the second fraction of parent particles is less than about 5 micron, or less than about 3 micron, or less than about 2 micron, or less than about 1 micron.

Embodiment 5 provides a particulate composition according to any one of embodiments 1 to 4, wherein the volume average particle size of the first fraction of parent particles is about 5 micron or greater, or about 10 micron or greater, or about 20 micron or greater.

Embodiment 6 provides a particulate composition according to any one of embodiments 1 to 5, wherein the volume average particle size of the first fraction of parent particles is between about 5 micron and about 500 micron, or between about 5 micron and about 200 micron, or between about 5 micron and about 100 micron, or between about 5 micron and about 50 micron.

Embodiment 7 provides a particulate composition according to any one of embodiments 1 to 6, wherein the volume average particle size of the composite particles is between about 5 micron and about 500 micron, or between about 5 micron and about 200 micron, or between about 5 micron and about 100 micron or between 5 micron and about 50 micron.

Embodiment 8 provides a particulate composition according to any one of embodiments 1 to 7, wherein the particulate composition comprises less than about 5% by weight of free parent particles having a volume average particle size of less than 5 micron based on the total weight of the parent particles.

Embodiment 9 provides a particulate composition according to any one of embodiments 1 to 8, wherein the particulate composition comprises less than about 4%, or less than about 3%, or less than about 2%, or less than about 1%, or less than about 0.5%, or less than about 0.1% of free parent particles having a volume average particle size of less than 5 micron.

Embodiment 10 provides a particulate composition according to any one of embodiments 1 to 9, wherein the composite particles comprise at least a portion of the second fraction of parent particles associated with an external surface of binder particles.

Embodiment 11 provides a particulate composition according to any one of embodiments 1 to 10, wherein the parent particles are selected from the group consisting of inorganic oxides, including metal and non-metal oxides, metals, metal halides, carbon, and polymers.

Embodiment 12 provides a particulate composition according to embodiment 11, wherein the inorganic oxide parent particles are selected from Groups 2, 4, 13, and 14 metal oxides, such as silica, alumina, magnesia, titania, zirconia and mixtures thereof.

Embodiment 13 provides a particulate composition according to embodiment 11, wherein the polymeric parent particles include finely divided polyolefins, such as finely divided polyethylene or polypropylene.

Embodiment 14 provides a particulate composition according to any one of embodiments 1 to 13, wherein the parent particles comprise one or more metal compounds.

Embodiment 15 provides a particulate composition according to embodiment 14, wherein the metal compounds include one or more transition metal compounds.

Embodiment 16 provides a particulate composition according to embodiment 15, wherein the transition metal compound is a bulky ligand transition metal compound.

Embodiment 17 provides a particulate composition according to any one of embodiments 1 to 16, wherein the parent particles comprise one or more metal alkyls, such as aluminum alkyls or alumoxanes.

Embodiment 18 provides a particulate composition according to any one of embodiments 1 to 17, wherein the parent particles comprise one or more boron containing olefin polymerization catalyst activators.

Embodiment 19 provides a particulate composition according to any one of embodiments 1 to 18, wherein the binder is a chemical species which produces composite particles having a volume average particle size which is within about 50% of the volume average particle size of the first fraction of parent particles, or within about 40%, or within about 30%, or within about 20%.

Embodiment 20 provides a particulate composition according to any one of embodiments 1 to 19, wherein the binder is selected from the group consisting of metal carboxylates, waxes, low molecular weight polymers, cross-linkable compounds, epoxies, metal hydroxide gels, and other materials that promote adhesion and agglomeration between fine particles.

Embodiment 21 provides a particulate composition according to embodiment 20, wherein the metal carboxylate comprises one or more aluminum carboxylates, such as aluminum stearate or aluminum di-stearate.

Embodiment 22 provides a particulate composition according to any one of embodiments 1 to 21, wherein the binder is present in an amount of up to about 25% by weight based on the total weight of the particulate composition, or between about 0.1% and about 25%, or between about 0.1% and about 15%, or between about 0.1% and about 10%, or between about 0.1% and about 5%.

Embodiment 23 provides a particulate composition according to any one of embodiments 1 to 22, wherein the particulate composition possesses catalytic activity.

Embodiment 24 provides a particulate composition according to any one of embodiments 1 to 23, wherein the parent particles possess catalytic activity.

Embodiment 25 provides a particulate composition according to any one of embodiments 1 to 23, wherein the composite particles possess catalytic activity.

Embodiment 26 provides a particulate composition according to any one of embodiments 23 to 25, wherein the catalytic activity is moderated by the binder.

Embodiment 27 provides a particulate composition according to embodiment 24, wherein the catalytic activity of fine parent particles is moderated or substantially eliminated.

Embodiment 28 provides a particulate composition according to embodiment 24, wherein the catalytic activity of parent particles having poor active site distribution is controlled or moderated.

Embodiment 29 provides a particulate composition according to any one of embodiments 23 to 28, wherein the particulate composition comprises one or more of increased density, increased surface conductivity or increased bulk conductivity, relative to a particulate composition absent binder.

Embodiment 30 provides a particulate composition according to any one of embodiments 1 to 29, wherein the binder controls the physical and/or chemical properties of the composite particles.

Embodiment 31 provides a particulate composition according to embodiment 30, wherein the physical and/or chemical properties include one or more of catalytic activity, particle density, particle magnetic properties and particle electric properties.

Embodiment 32 provides a particulate composition according to embodiment 30, wherein the control improves one or more aspects of process performance when the particulate composition is used therein.

Embodiment 33 provides a particulate composition according to embodiment 32, wherein the aspects of process performance include particle fluidization, particle segregation within a bed or system, tailored catalytic activity and catalytic selectivity.

Embodiment 34 provides a process for preparing a particulate composition according to any one of embodiments 1 to 33 comprising the step of contacting at least one binder with parent particles under conditions effective to produce

a) a first fraction of parent particles; and
b) composite particles, said composite particles comprising the binder and a second fraction of parent particles,
wherein the second fraction of parent particles has an average particle size which is less than the average particle size of the first fraction of parent particles; and
wherein the first and second fractions of parent particles comprise the same parent material.

Embodiment 35 provides a process according to embodiment 34, wherein the binder is contacted with the parent particles prior to the parent particles being subjected to processing.

Embodiment 36 provides a process according to embodiment 34, wherein the binder is added to the parent particles during processing, for example added to a reactor, to a transfer system or to a storage vessel.

Embodiment 37 provides a process, said process comprising the step of conveying a particulate composition according to any one of embodiments 1 to 33.

Embodiment 38 provides a process according to embodiment 37, wherein the conveying occurs in a pipe, a vessel, a mixer, a transfer line, a reactor and the like.

Embodiment 39 provides a process according to embodiment 38, wherein the conveying occurs in a fluidized bed reactor.

Embodiment 40 provides a process according to any one of embodiments 37 to 39, wherein the process is selected from gas phase polymerization of olefins, phthalic and maleic anhydride synthesis, Fischer Tropsch synthesis of hydrocarbons, fluidized catalytic cracking and acrylonitrile synthesis.

Embodiment 41 provides a process according to any one of embodiments 37 to 40, wherein the particulate composition improves the operational performance of the process relative to a particulate composition absent binder.

Embodiment 42 provides a process according to embodiment 41, wherein the operational performance improvement is characterized by one or more of, increasing process on-line time, reducing particle entrainment and reducing equipment fouling.

Embodiment 43 provides a process for polymerizing olefins comprising contacting olefins with one or more particulate compositions according to any one of embodiments 1 to 33, said particulate compositions comprising:

a) a first fraction of parent particles; and
b) composite particles, said composite particles comprising a binder and a second fraction of parent particles,
wherein the second fraction of parent particles has a maximum particle size which is less than the volume average particle size of the first fraction of parent particles;
wherein the first and second fractions of parent particles comprise the same parent material; and
wherein the parent particles comprise a co-catalyst or activator, and one or more catalyst compounds comprising a titanium, a zirconium, or a hafnium atom.

The contents of all references, including published patents and patent applications cited throughout the application are hereby incorporated by reference.

It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

1. A particulate composition comprising:
a) a first fraction of parent particles; and
b) composite particles, said composite particles comprising a binder and a second fraction of parent particles,
wherein the second fraction of parent particles has a maximum particle size which is less than the volume average particle size of the first fraction of parent particles; and
wherein the first and second fractions of parent particles comprise the same material.

2. A particulate composition according to claim 1, wherein the second fraction of parent particles has a maximum particle size which is less than 50% of the volume average particle size of the first fraction of parent particles.

3. A particulate composition according to claim 1, wherein the volume average particle size of the composite particles is between about 5 micron and about 500 micron, or between about 5 micron and about 200 micron, or between about 5 micron and about 100 micron or between 5 micron and about 50 micron.

4. A particulate composition according to claim 1, wherein the particulate composition comprises less than about 5% by weight of free parent particles having a volume average particle size of less than 5 micron based on the total weight of the parent particles.

5. A particulate composition according to claim 1, wherein the composite particles comprise at least a portion of the second fraction of parent particles associated with an external surface of binder particles.

6. A particulate composition according to claim 1, wherein the parent particles are selected from the group consisting of inorganic oxides, including metal and non-metal oxides, metals, metal halides, carbon, and polymers.

7. A particulate composition according to claim 6, wherein the inorganic oxide parent particles are selected from Groups 2, 4, 13, and 14 metal oxides, such as silica, alumina, magnesia, titania, zirconia and mixtures thereof.

8. A particulate composition according to claim 6, wherein the polymeric parent particles include finely divided polyolefins, such as finely divided polyethylene or polypropylene.

9. A particulate composition according to claim 1, wherein the parent particles comprise one or more metal compounds.

10. A particulate composition according to claim 1, wherein the parent particles comprise one or more metal alkyls, such as aluminum alkyls or alumoxanes.

11. A particulate composition according to claim 1, wherein the parent particles comprise one or more boron containing olefin polymerization catalyst activators.

12. A particulate composition according to claim 1, wherein the binder is a chemical species which produces composite particles having a volume average particle size which is within about 50% of the volume average particle size of the first fraction of parent particles, or within about 40%, or within about 30%, or within about 20%.

13. A particulate composition according to claim 1, wherein the binder is selected from the group consisting of metal carboxylates, waxes, low molecular weight polymers, cross-linkable compounds, epoxies, metal hydroxide gels, and other materials that promote adhesion and agglomeration between fine particles.

14. A particulate composition according to claim 13, wherein the metal carboxylate comprises one or more aluminum carboxylates, such as aluminum stearate or aluminum di-stearate.

15. A particulate composition according to claim 1, wherein the particulate composition possesses catalytic activity.

16. A particulate composition according to claim 15, wherein the catalytic activity is moderated by the binder.

17. A particulate composition according to claim 1, wherein the particulate composition comprises one or more of increased density, increased surface conductivity or increased bulk conductivity, relative to a particulate composition absent binder.

18. A particulate composition according to claim 1, wherein the binder controls the physical and/or chemical properties of the composite particles.

19. A particulate composition according to claim 18, wherein the physical and/or chemical properties include one or more of catalytic activity, particle density, particle magnetic properties and particle electric properties.

20. A process for preparing a particulate composition comprising the step of contacting at least one binder with parent particles under conditions effective to produce
a) a first fraction of parent particles; and
b) composite particles, said composite particles comprising the binder and a second fraction of parent particles,
wherein the second fraction of parent particles has an average particle size which is less than the average particle size of the first fraction of parent particles; and
wherein the first and second fractions of parent particles comprise the same parent material.

21. A process according to claim 20, wherein the binder is contacted with the parent particles prior to the parent particles being subjected to processing.

22. A process according to claim 20, wherein the binder is added to the parent particles during processing, for example added to a reactor, to a transfer system or to a storage vessel.

23. A process, said process comprising the step of conveying a particulate composition according to claim 1.

24. A process according to claim 23, wherein the process is selected from gas phase polymerization of olefins, phthalic and maleic anhydride synthesis, Fischer Tropsch synthesis of hydrocarbons, fluidized catalytic cracking and acrylonitrile synthesis.

25. A process according to claim 23, wherein the particulate composition improves the operational performance of the process relative to a particulate composition absent binder.
